(19) United States
(12) Patent Application Publication
(10) Pub. No.: US 2021/0300790 A1
(43) Pub. Date: Sep. 30, 2021

(54) WASTE TREATMENT APPARATUS AND METHOD

(71) Applicant: SEM ENERGY LIMITED, Potterton (GB)

(72) Inventors: William Alexander Beveridge, Edzell (GB); Leigh Cassidey, Rhynie (GB)

(73) Assignee: SEM ENERGY LIMITED, Potterton (GB)

(21) Appl. No.: 17/268,916

(22) PCT Filed: Aug. 16, 2018
(86) PCT No.: PCT/GB2018/000114

§ 371 Date: Feb. 16, 2021

(30) Foreign Application Priority Data
Aug. 16, 2017 (GB) 1713120.2

(51) Int. Cl. C02F 1/28; C02F 11/13; C02F 1/00; C02F 1/36; C05F 3/06; C05F 7/00

(52) U.S. Cl. CPC C02F 1/286; C02F 11/13; C02F 1/004; C02F 2103/20; C05F 3/06; C05F 7/005; C02F 1/36

(57) ABSTRACT

The present invention relates to apparatus and methods of liquid purification and the subsequent production of useful by-products. A variety of liquids may be purified by the method and apparatus, including water and hydrocarbon mixtures/sludges. The method of treating waste products comprises the steps of adding an absorbent to the waste product to form a absorbed solid, semi-solid or fluid matrix, the matrix being then subjected to an increase in temperature. The apparatus comprises a material inlet, a heated generator tube, one or more outlets being connected with the heated generator tube, and a material outlet.

### FIELD OF THE INVENTION

The present invention relates to apparatus and methods of liquid purification and the subsequent production of useful by-products. A variety of liquids may be purified by the method and apparatus, including water and hydrocarbon mixtures/sludges.

### BACKGROUND TO THE INVENTION

Contaminated water is a world-wide problem; water may be contaminated with numerous contaminants that prevents its safe further use. Treating the water to produce water that may be further used, such as for drinking, for agricultural irrigation, livestock use, etc, is a desirable goal, especially where water sources are put under increasing pressure by greater usage.

One such area of problem is slurry pits or lagoons, where large amounts of agricultural waste, which may include animal waste, are stored either in open areas or in tanks.

Ordinarily, the slurry is left for a considerable period of time to break down into a usable fertilizer. Meantime, the slurry represents a hazard on several levels. Firstly, the storage area itself represents a potential drowning hazard to people and animals within its vicinity. Second, over time the slurry pits release gases which may be undesirable to be emitted, such as carbon dioxide, methane, hydrogen sulphide and ammonia and thirdly, the slurry itself may contaminate the are of land in which it is sited.

A similar problem exists with oil sludges, thick viscous mixtures of hydrocarbons, which may advantageously be separated into useful volatiles for re-use, and inert solids.

### SUMMARY OF THE INVENTION

According to a first aspect of the present invention there is provided a method of treating waste products comprising the steps of adding an absorbent to the waste product to form a absorbed solid, semi-solid or fluid matrix, the matrix being then subjected to an increase in temperature.

By waste products it will be understood that this includes effluent, waste-water, oil sludge, or even by-products of other processes (industrial, agricultural or otherwise).

The matrix may be fed through a channel, tube or other feature; the channel, tube or other feature may have a length and a bottom surface along which the matrix traverses, and there may be a temperature increase applied along the feature's length.

The feature may include one or more fluid aperture(s) along at least a portion of the bottom surface of the feature, and a gas may be injected through said one or more aperture(s).

The gas may be nitrogen.

Ultrasound may be applied to the matrix.

Liquid obtained from the method may be further treated by passing it through further absorbent.

The absorbent may be draff.

Liquid obtained from the method may be further treated by use of a vapour vacuum process.

There may be a plurality of features.

The matrix may be macerated prior to entry into the one or more of the features.

The increase in temperature may be a step change (multiple or singular), incremental, or a gradient.

The matrix may be fed through a channel, tube or other feature, the feature having a length and there being a temperature gradient applied along the feature's length.

The matrix may be subjected to an impelling or propelling force to assist its transit across the feature.

The feature may be a tube which may include an impelling or propelling device to force the matrix along the feature.

The temperature gradient may extend beyond the boiling point of water.

The temperature gradient may be from around ambient temperature (5-30° C.) to a temperature of around 650° C.

It will be understood by the skilled addressee that the temperature gradient may be tuned for specific criteria, such as length of feature, specific composition of the matrix, ambient conditions and so forth.

The temperature gradient causes some or all of the water in the matrix to be evaporated as steam, which may then be drawn off the matrix, to form a dried, sold residue, or at least a drier, more solid residue.

The water may be then further treated by passing I through further absorbent.

The further absorbent may be draff.

The water may be then further treated by use of a vapour vacuum process.

Moreover, the temperature gradient may be tuned to allow further volatile substances to be drawn off at separate points along the feature.

Such volatile substances may include: fats, oils, greases and petroleum and non-petroleum derived hydrocarbons.

According to second aspect of the present invention there is provided apparatus for treating waste products, the apparatus comprising a material inlet, a heated generator tube, one or more outlets being connected with the heated generator tube, and a material outlet.

The heated generator tube may have a length and a bottom inner surface, and there may be a temperature increase applied along the heated generators tube's length.

There may be one or more fluid aperture(s) along at least a portion of the bottom inner surface of the heated generator tube.

There may be a nitrogen supply connected to said one or more fluid apertures.

There may be one or more ultrasonic transducer(s) or atomizer(s).

The apparatus may comprise a filter having further absorbent.

The absorbent may be draff.

The apparatus may further comprise a vacuum pump to lower the boiling point of fluid contained in the matrix.

The apparatus may further include one or more further features.

The apparatus may further include one or more macerators.

The apparatus may further include one or more pumps.

The apparatus may further include one or more pelletisers.

The apparatus may be suitable for treating a matrix comprising a mixture of a liquid or semi-solid waste product and a suitable absorbent.

The absorbent may be draff, and may be draff obtained as a by-product of whisky production.

The heated transport tube may have a length (which may be measured vertically, horizontally or an inclination there-between) and that length may be subject to a temperature gradient.

The temperature gradient may increase from a first temperature located proximal the material input to a second temperature located proximal the material output.

The first temperature may be lower than the second temperature.

The temperature gradient may be from around ambient temperature (5-30° C.) to a temperature exceeding the boiling point of water 100° C.

The temperature gradient may be from around ambient temperature (5-30° C.) to a temperature of around 800° C.

The temperature gradient may be from around ambient temperature (5-30° C.) to a temperature of around 1600° C.

A heating coil surrounding the heated transport tube may provide the temperature gradient.

The material inlet may include apparatus to agitate or break up the material prior to transport along the heated transport tube.

The material inlet may include or comprise pre-treatment apparatus.

The pre-treatment apparatus may include a hydro-cyclone.

The pre-treatment apparatus may include a vacuum enhanced induction coil.

There may be provided an impeller or propeller to force material along the heated transport tube.

The impeller or propeller may be a screw-type pump located at least partially within the heated transport tube.

The material outlet may include a pelletiser.

Condensate outlets may extend from the heated transport tube. These may allow condensate, including water, to be drawn off in a fluid form, including as a vapour.

The condensate outlets may feed into further processing or filtration apparatus.

### BRIEF DESCRIPTION OF THE DRAWINGS

Embodiments of the invention will now be described, by way of example only, with reference to the following drawings, in which:

FIG. 1 is a perspective view of a first embodiment apparatus and method according to the various aspects of the present invention;

FIG. 2 is a perspective view of the central processor of the apparatus of FIG. 1;

FIG. 3 is a perspective view of a second embodiment apparatus according to a second aspect of the present invention;

FIG. 4 is a perspective view of a third embodiment apparatus and method according to the various aspects of the present invention;

FIG. 5 is a perspective view of a fourth embodiment and method according to the various aspects of the present invention;

FIG. 6 is a schematic representation of a fifth embodiment of the present invention according to the various aspects of the present invention;

FIG. 7 is a schematic representation of a sixth embodiment of the present invention according to the various aspects of the present invention;

FIG. 8 is a side elevation of a first generator usable with the apparatus of FIG. 6 or 7;

FIG. 9 is a plan view of a first generator usable with the apparatus of FIG. 6 or 7;

FIG. 10 is a side sectional elevation of a first feed tube usable with the apparatus of FIG. 6 or 7;

FIG. 11 is a plan sectional view of a first generator usable with the apparatus of FIG. 6 or 7;

FIG. 12 is an end elevation of a first feed tube usable with the apparatus of FIG. 6 or 7;

FIGS. 13 to 21 are various detail views of the first generator of FIGS. 8 to 12;

FIG. 22 is a side elevation of a second generator usable with the apparatus of FIG. 6 or 7;

FIG. 23 is a plan view of a second generator usable with the apparatus of FIG. 6 or 7;

FIG. 24 is a sectional side elevation of a second feed tube usable with the apparatus of FIG. 6 or 7;

FIG. 25 is an end elevation of a second generator usable with the apparatus of FIG. 6 or 7;

FIGS. 26 to 29 are various detail views of the second generator of FIGS. 22 to 25;

FIG. 30 is a side elevation of a third generator usable with the apparatus of FIG. 6 or 7;

FIG. 31 is a plan view of a third generator usable with the apparatus of FIG. 6 or 7;

FIG. 32 is a side sectional elevation of a third feed tube usable with the apparatus of FIG. 6 or 7;

FIG. 33 is an end elevation of a third generator usable with the apparatus of FIG. 6 or 7;

FIGS. 34 to 37 are various detail views of the third generator of FIGS. 30 to 33; and

FIG. 38 is a side sectional elevation of an assembly comprising a first, second and third generators.

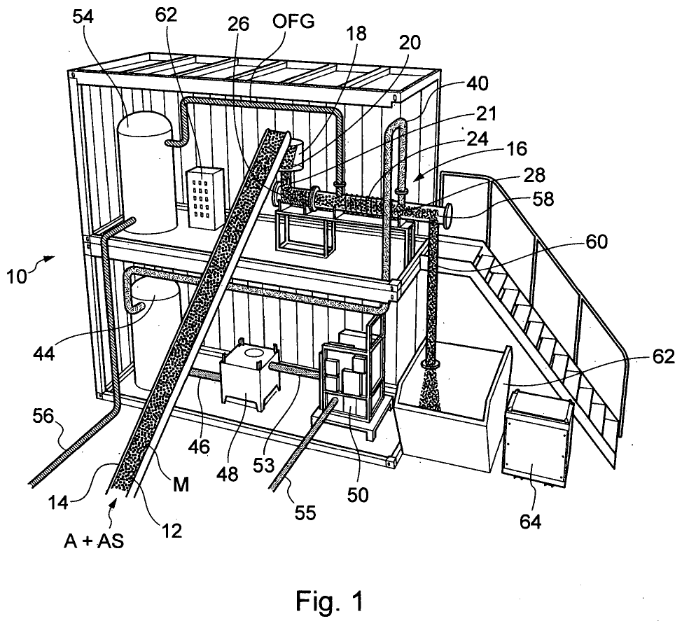

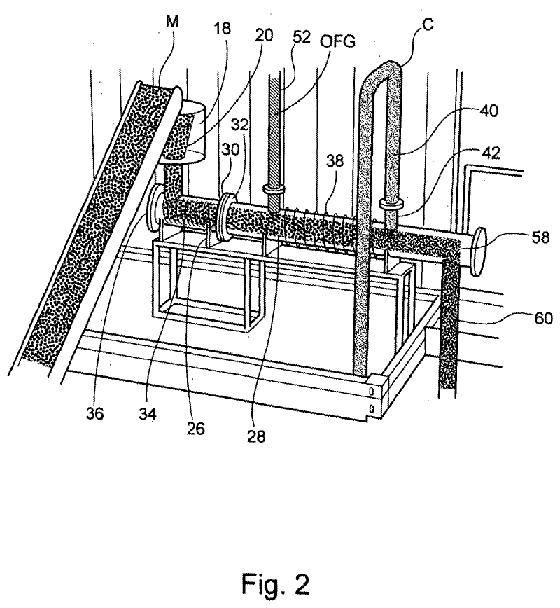

Referring to the drawings and initially to FIG. 1, a first embodiment waste product method and apparatus 10 are depicted. The method and apparatus are being used in the present embodiment to treat agricultural slurry, but it will be appreciated by the skilled addressee that this apparatus and method may be used to treat a multitude of waste products and by-products and is not limited to merely agricultural slurry.

Agricultural slurry AS is combined with an absorbent A to form a matrix M. The agricultural slurry AS in the present embodiment will be that typically found in slurry lagoons or pits, and will have an appreciable proportion of water. This water is unusable given the other contaminants present within the slurry AS, particularly animal faeces.

Conveyor belt 12 positioned in conveyor channel 14 transports the matrix M towards a central processor 16. Matrix M will usually form as a relatively thick and viscous slurry.

Absorbent A in the present embodiment is draff obtained as a by-product of whisky production. It will be appreciated by the skilled addressee that other types of draff, from brewing for example, or indeed other forms of suitable absorbent may be usable in the process. Such an absorbent derived from whisky draff may be found in PCT/GB2008/003308, the contents of which are hereby incorporated by reference.

Central processor 16 is also an embodiment of the second aspect of the present invention in it own right, absent from the other features of the apparatus 10.

Central processor 16 comprises a pan-type mixer 18, with agitating rotor blades 20 rotating therein. The slurry-form matrix M falls from the conveyor belt 12 into the pan-type mixer 18 under gravity and is broken up under the action of blades 20.

The matrix M falls through the blades 20 through vertical matrix feed tube 22 towards generator 24.

Generator 24 comprises an initial horizontal pipe section 26 and a secondary heated pipe section 28. The two pipe sections 26,28 are joined together via respective pipe flanges 30,32.

An hydraulic screw 34 is located within the initial horizontal pipe section 26. Electric motor 36 located on the first end of the initial horizontal pipe section 26 (the end located distally from the secondary heated pipe section 28 and flanges 30,32 powers the hydraulic screw 34.

Hydraulic screw 34 propels the matrix M along the generator 24 towards the secondary heated pipe section 28.

A heating coil 38 surrounds the outer surface of the secondary heated pipe section 28. In the present embodiment, the heating coil 38 surrounds approximately 60% of the mid-section of the secondary heated pipe section 28. The heating coil 38 in the present embodiment is an electrical heating element. The heating coil 38 raises the temperature within the generator from the ambient temperature to a temperature beyond the boiling point of water, i.e. 100° C. at standard atmospheric pressure. In the present embodiment, the temperature gradient along the length of the heating coil 38 is from around ambient temperature (5-30° C.) to a temperature of around 800° C., although it will be appreciated that temperature ranges may exceed that level (or indeed be under) depending on the specific application, particularly the substance being processed.

An effluent inlet pipe 52 branches into the secondary heated pipe section 28. An effluent tank 54 is positioned at the other end of the inlet pipe 52, the inlet pipe 52 connecting to the upper portion of the effluent tank 54.

Oils, fats and greases OFG are fed into the effluent tank 54 and transported through the inlet pipe 52 into the start point of the secondary heated pipe section 28. Effluent inlet pipe 56 extends into the lower portion of the effluent tank 54. Oils, fats and greases OFG are transported into the effluent tank 54 via effluent inlet pipe 56. The oils, fats and greases OFG may come from a separate source.

The oils, fats and greases OFG are mixed with the matrix M within the secondary heated pipe section 28.

The water W within matrix M evaporates out of matrix M as steam S. Further chemicals will also evaporate out of the matrix M at this point, creating a gaseous condensate C.

Condensate pipe 40 is joined to a condensate outlet 42 located on the sidewall of the secondary heated pipe section 28, downstream from the OFG inlet point. The steam outlet 42 comprises a flanged pipe section extending perpendicularly from the secondary heated pipe section 28.

A condensate tank 44 is joined to the other end of the steam pipe 40, the condensate tank 44 being a known tank design, in which the gaseous condensate C condenses into a liquid.

Condensate C is transported from the condensate tank 44 along water pipe 46 to a further filtration unit 48. Filtration unit 48 contains further absorbent A. Condensate C enters the filtration unit 48 at the bottom and passes through layers of the further absorbent A.

A pump filter unit 50 is attached to the filtration unit 48 and draws filtered water W from the upper portion of the filtration unit 48 along a water pipe 53 through the pump filter unit 50 and further along another water pipe 55.

Pump filter unit 50 includes further filtration apparatus within it, to further decontaminate water W. This is especially useful when water W may be contaminated with heavy metals and/or organic waste. A vacuum vapour filtration process is used within the pump filter unit 50 in the present embodiment.

Water W, being further decontaminated by filtration unit 48 and pump filter unit 50, should be even further free from contaminants, and be usable for a number of purposes, such as use on crops, use in industrial processes or even as potable water.

Matrix M, absent the condensate C, continues along the secondary heated pipe section 28. The matrix M is drier by this point as a large proportion of water W has been removed in the condensate C.

A pelletiser 58 is located at the distal end of the secondary heated pipe section 28. Pelletiser 58 turns the matrix M into pelleted product 60. Pelleted product 60 is collected in a skip 62 and may either be safely disposed of, or given that it will contain many useful nutrients, may be used as a fertiliser for agricultural purposes.

A control unit 62 and control cabin 64 provide controls for the different variables within the process, such as temperature, flow-rate, etc.

The skilled addressee will appreciate that depending on the inputs to the process, the pelleted product 60 may achieve a number of uses, for example animal feed, turning waste products into useful products. Moreover, it will be appreciated by the skilled addressee that this process allows for the recycling of otherwise useless and indeed potentially harmful waste products into water W and useful by-products such as fertiliser and/or animal feed.

In an agricultural setting, the method and apparatus of the present invention allows waste to be treated and useful products to be obtained at the same time. The method and apparatus may even use hydrocarbons, such as methane, contained within and given off by the waste products as a power source. This creates a beneficial and environmentally friendly process that assists agriculture and mitigates the requirement for agricultural slurry to be transported off site for processing.

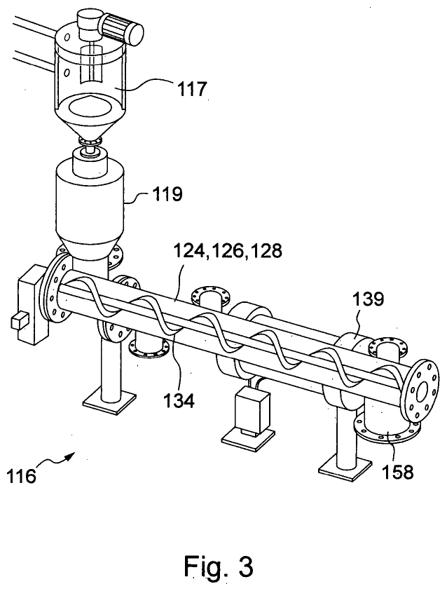

Turning to FIG. 3, a second embodiment central processor 116 is depicted. This is largely identical to the first embodiment generator 16 described above, and very similar or identical components are identified using the same numbering scheme as above, albeit prefixed with a “1”.

In the second embodiment generator 124, the initial horizontal pipe section 126 and secondary heated pipe section 128 are not separate sections of pipe, but rather are one continuous pipe section. Moreover, hydraulic screw 134 is not confined to the initial horizontal pipe section 126 but extends through the secondary heated pipe section 128 as well. Heating coil 138 is also surrounded by and located within an insulating jacket 139.

At the inlet to the generator, the pan-type mixer is replaced with two separate components: an initial hydro-cyclone 117 and a vacuum enhanced induction coil 119 which pre-treat the matrix M prior to entry into generator 124. As these may both further dry matrix M, the longer hydraulic screw 134 may be useful in forcing the matrix M along the generator 124 to the pelletiser 158.

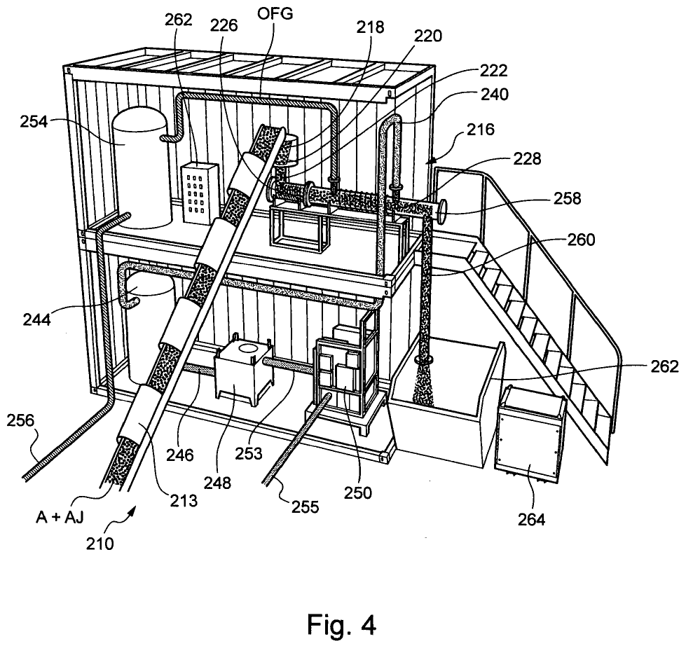

A third embodiment waste product method and apparatus 210 are depicted in FIG. 4. These are largely identical to the first embodiment method and apparatus 10 described above, and very similar or identical components are identified using the same numbering scheme as above, albeit prefixed with a “2”.

The third embodiment contains two appreciable differences from the first embodiment.

First, and the more minor of the two differences, is that a conveyor tube 213 replaces conveyor belt 12 and the conveyor channel 14. This may be more suitable for a wetter matrix M.

Second, is that instead of being fed into the process, the oils, fats and greases OFG are being drawn out of the process via an effluent outlet pipe 252 which branches out of the secondary heated pipe section 228. The effluent tank 254 is likewise positioned at the other end of the outlet pipe 252, the outlet pipe 252 connecting to the upper portion of the effluent tank 254.

The oils, fats and greases OFG evaporate out of the matrix M because of the temperature at the specific point in the generator 216.

Oils, fats and greases OFG are fed into the effluent tank 54 by effluent outlet pipe 252 which connects into the upper portion of the effluent tank 254. Oils, fats and greases OFG are transported out of the effluent tank 254 via the effluent outlet pipe 256 located at the lower portion of the effluent tank 254. The oils, fats and greases OFG may be then taken for further processing, disposal or use.

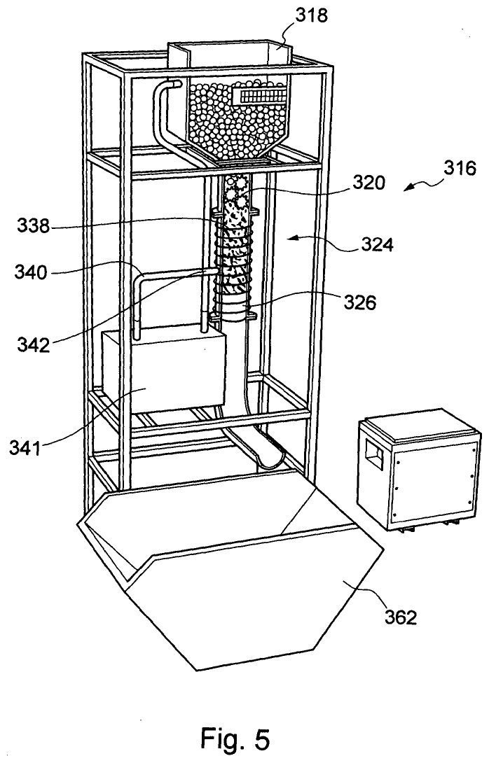

Turning to FIG. 5, a third embodiment processor 316 is depicted. This is largely similar in function to the first and second embodiment processors 16, 116 described above, and very similar or identical components are identified using the same numbering scheme as above, albeit prefixed with a “3”.

The third embodiment processor 316 is mainly different in that all major components are arranged in a vertical stack. This is advantageous where space may be limited.

Matrix M is fed into an inlet hopper 318 and falls under gravity to grinders 320 which break it up.

Matrix M then travels through vertically arranged generator 324, which comprises a vertical feed pipe 326 surrounded by an electrical heating coil 338.

Condensate pipe 340 is joined to a condensate outlet 342 located on the sidewall of the vertical feed pipe 326. OFG inlets/outlets are omitted in this relatively simpler variant.

A separator 344 takes the condensate C from the condensate pipe 340 and separates it into water W and any waste products.

Dry matrix M falls from the end of generator 324 and into skip 362. Depending on the constituent qualities of dry matrix M, it may be disposed of, or used in the manners described above.

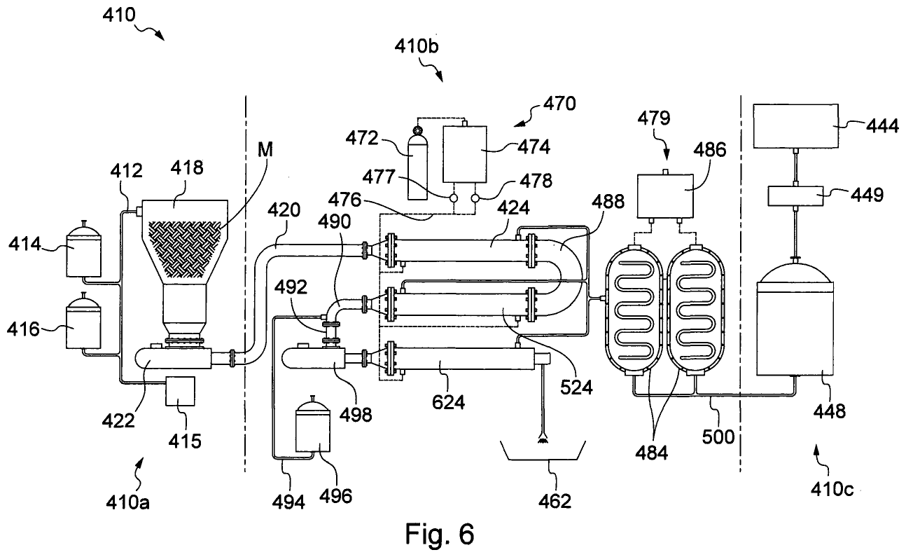

A fourth embodiment waste product method and apparatus 410 are depicted in FIG. 6. These are largely similar to the first embodiment method and apparatus 10 described above, and very similar or identical components are identified using the same numbering scheme as above, albeit prefixed with a “4”, except as described below.

Apparatus 410 comprises three discrete sections: a feed skid 410a (the left hand side of FIG. 6); a generator skid 410b (the centre portion of FIG. 6); and a treatment skid 410c (the right hand side of FIG. 6).

The feed skid 410a comprises a hopper/macerator unit 418 into which the matrix M may be fed. The present embodiment will be fed with a positive displacement pump (not shown). This positive displacement pump (not shown) will not intrude on the induction heated portion of the system but the feed will be transported via pipework (not shown).

Slurry matrices M will either be pre-homogenised or (dependent on slurry type) the pump itself will have in built macerators etc for this purpose. There may be feed-back loops from the condensate end to provide additional moisture for the feed if necessary. A progressive cavity pump (not shown) may be employed because of their versatility; however the important thing to note is that it is a positive displacement pump which therefore provides a pressure seal. This allows a vacuum to be applied to the system greatly reducing the boiling point of processed liquids.

A chemical feed inlet line 412 feeds into the upper portion of the hopper/macerator unit 418, and which may be used to deliver additional chemicals to the matrix M to enable such chemicals to be present in the output product. This may be used to improve fertiliser quality for example.

The fourth embodiment may be used for agricultural slurry, so in the present embodiment a phosphate silo 414 and a sulphate silo 416 are provided, which both feed into the chemical feed inlet line 412. The skilled addressee will appreciate that these may employ separate feed lines, and indeed further or alternative silos/chemicals may be employed.

A bund and sump pump assembly 415 is provided on a first end of the chemical feed line 412, and this enables the contents of the silos to be administered to the hopper 418.

The matrix M, having passed through hopper 418 and potentially having phosphates/sulphates added as required, is forced along pipe 420 by first pump 422. First pump 422 in the present embodiment is a Progressive Cavity Pump.

Pipe 420 in the present embodiment is low pressure Chiksan® hose, but suitable alternatives may be used. The pipe 420 marks the nominal beginning of the Generator Skid portion of the apparatus.

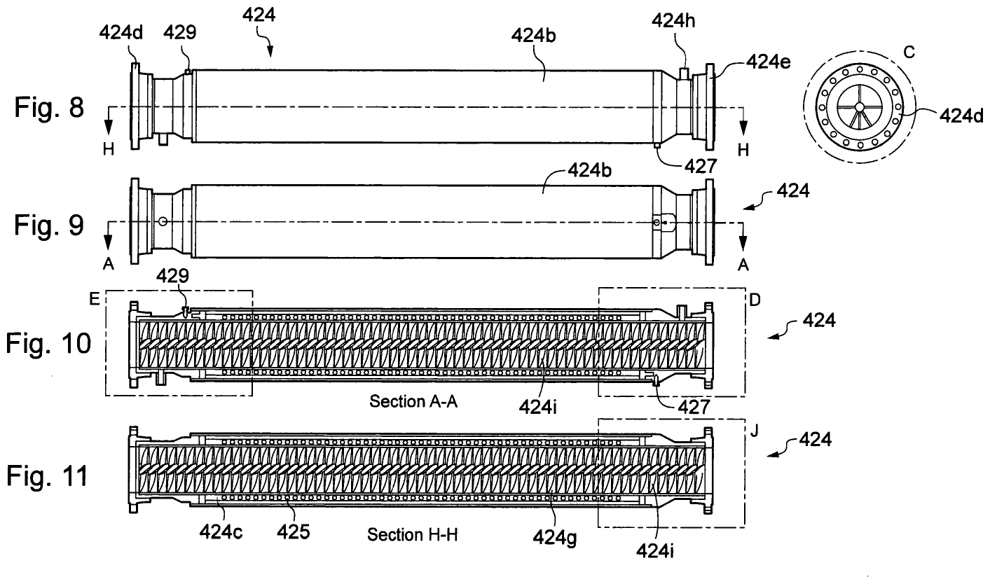

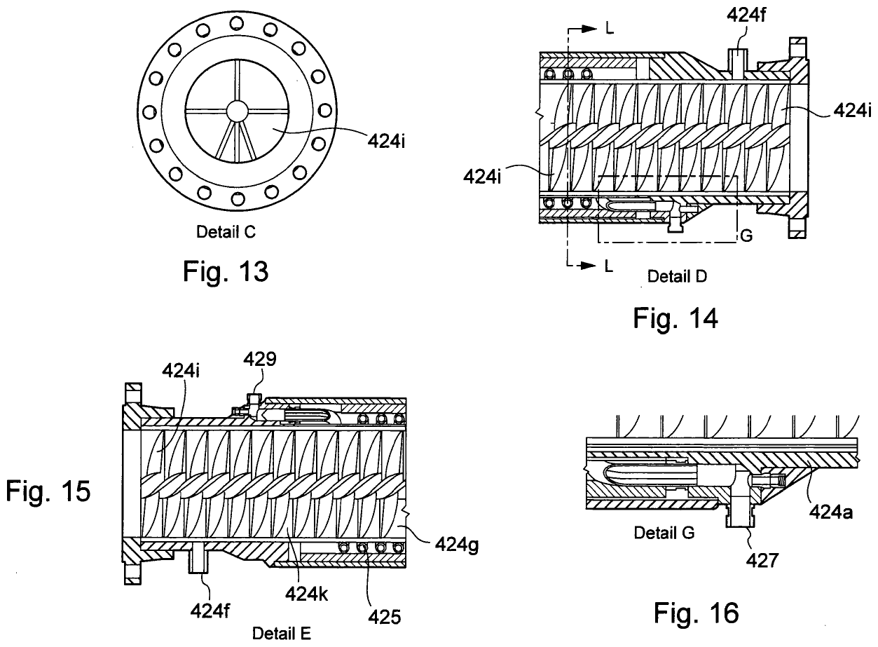

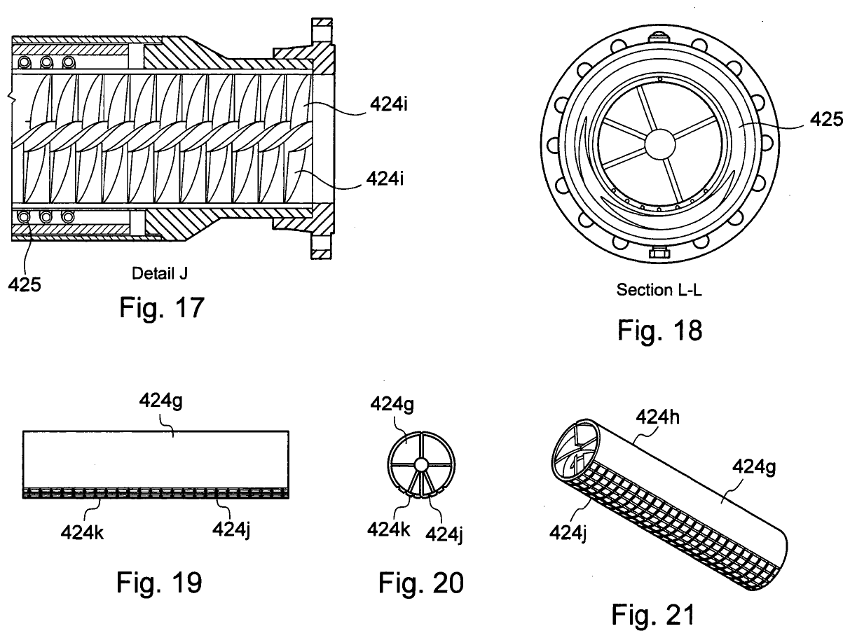

A first generator 424 attaches to the distal end of pipe 420. The first generator 424 is shown in more detail in FIGS. 8 to 21.

The first generator 424 comprises a central tube section 424a, surrounded by an outer sleeve 424b. The outer sleeve 424b is slightly shorter than the central tube section length 424a, thereby exposing part of the tube section 424a at each extremity.

A cavity 424c is defined between the sleeve 424b and a heating coil 425 is located within the cavity 424c. A first flange 424d is located at the first end of the first generator 424 to enable attachment with pipe 420 and a second flange 424e is located at the second end of the first generator 424 to enable attachment as will subsequently be described. Coolant inlet 427 and outlet ports 429 are located at either end of the sleeve 424b, and these supply a water jacket (not shown) to enable temperature regulation of the heated internals of the generator.

A nitrogen inlet nipple 424f is located on the central tube section 424a between the first flange. 424d and sleeve 424b. The nitrogen inlet nipple 424f is located on the underside of the generator when in situ.

A ferromagnetic heating element 424g is located within the body of the central tube section 424a. The ferromagnetic heating element 424g comprises a tubular outer body 424h within which two helical screws 424i are formed, creating a generally helical fluid path through the generator 424. This increases the surface area from which heat may be applied to the transiting matrix M as it is forced through the generator 424 by virtue of the action of the pump 422. The inner surface of the ferromagnetic heating element 424g and the helical screws 424i are coated with a high temp ceramic non-stick coating, such as Duraceram® coating. The ferromagnetic heating element 424g is induction heated by the heating coil 425.

The underside of the ferromagnetic heating element 424g has a plurality of channels 424j formed into it in a rectangular criss-cross pattern as can be best seen in FIG. 21. Small bores 424k are provided at the junctions of the channels 424j. The plurality of channels 424j and bores 424k are in fluid communication with the nitrogen inlet nipple 424f.

A nitrogen supply system 470 is provided which feeds nitrogen to the first, second and third generators. The nitrogen supply system comprises a nitrogen generator 472 which feeds into an accumulator 474, and subsequently into a nitrogen supply line 476. Two, parallel redundant pressure regulators 478 are provided between the accumulator 474 and the nitrogen supply line 476.

The nitrogen supply line 476 attaches to the nitrogen inlet nipple 424f. Nitrogen flows into the plurality of channels 424j and out through the bores 424k, creating a plurality of nitrogen jets into the lowermost portion of the ferromagnetic heating element 424g. This creates a gaseous fluidised bed which agitates the matrix M increasing the surface area exposed to heat but also causing a portion of the entrained liquid within the matrix M to vaporise rather than evaporate.

A vapour outlet nipple 424h is located on the central tube section 424a between the sleeve 424b and the second flange 424d and allows fluid flow out of the centre of the generator as will subsequently be described. The vapour outlet nipple 424h is located on the top of the generator 424 when in situ.

A vacuum assembly 479 is attached via vapour supply lines 480 to the vapour outlet nipple 424h, and analogous nipples on the subsequent generators as will subsequently be described.

The vacuum assembly 479 comprises two parallel vacuum condensers 484, with a vacuum pump 486 creating the necessary vacuum pressure. The vacuum pump 486 may be further connected to chemical scrubbers or filters depending on the composition of the vapour/gas drawn off the vacuum condensers.

Since a positive displacement pump is used, it therefore provides a pressure seal. This assists the vacuum on the system significantly reducing the boiling point of processed liquids within matrix M. Evaporate and vapour drawn off are then condensed in vacuum condensers 484.

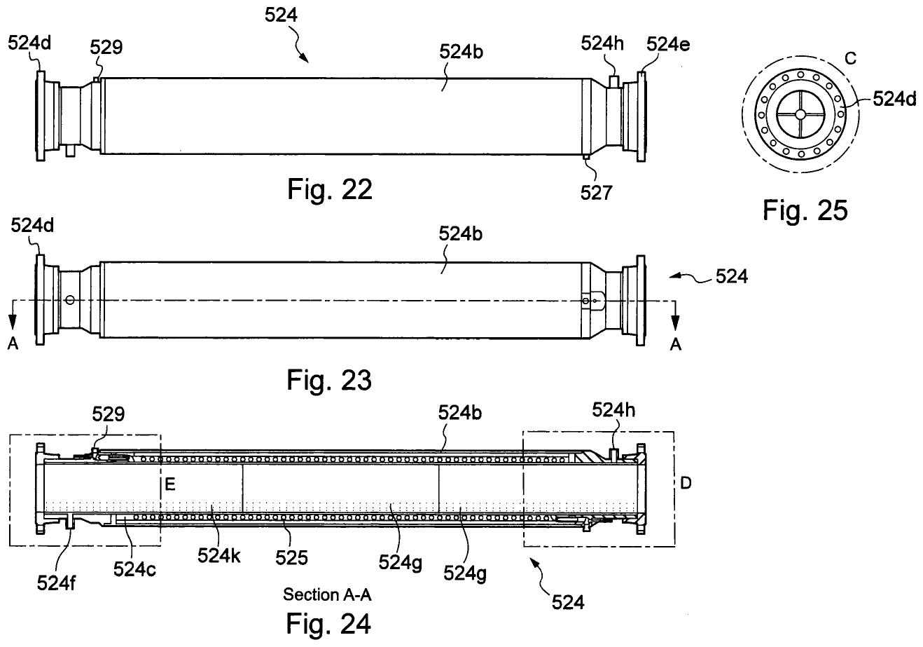

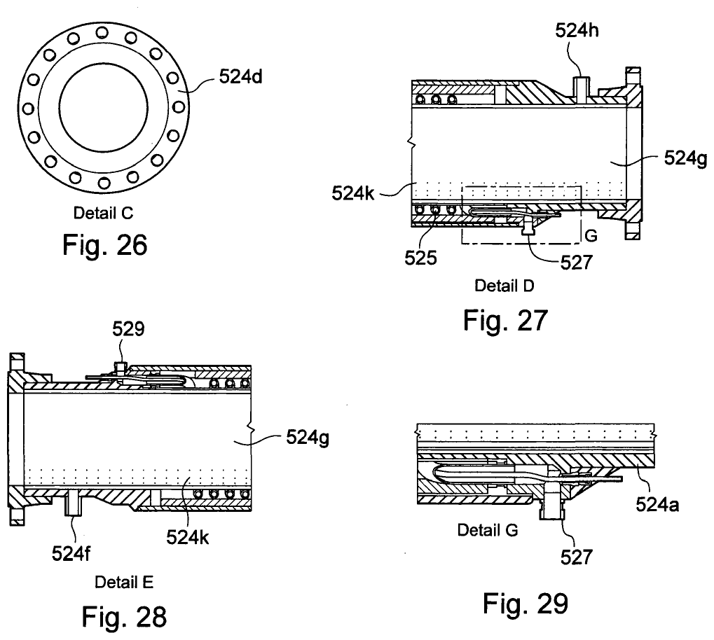

A second generator 524 is attached to the first generator 424 by a simple U-bend pipe 488. The second generator 524 is quite similar to first generator 424 and analogous components use the same lettering scheme as used above e.g. the central tube section is 524a, the sleeve is 524b and so forth. FIGS. 22 to 29 show the second generator 524 in greater detail.

The main difference is that the ferromagnetic heating element 524g is a simple tube, and there are no helical blade inserts.

As liquid is drawn off the matrix M in the first generator, the matrix M becomes less fluid and thus the relatively smooth bore of the second generator 524 aids the flow of matrix M.

As with the first generator 424, a gaseous nitrogen bed is applied to the lower portion of the generator interior, with vapour being drawn off under vacuum.

It is important to note that the first two generator sections take advantage of heat recovery via convection as they are opening connected in series.

A third pipe 490 connects the second generator 524 to a vertical macerator 492. By this stage the matrix M may be even less fluid and be relatively dry, and the vertical macerator 492 homogenises the matrix M.

A second chemical feed inlet line 494 feeds into the lower portion of the third pipe 490 just prior to vertical macerator 492, and which may be used to deliver additional chemicals to the matrix M to enable such chemicals to be present in the output product. A nitrate silo 496 supplies feed line 494.

A second pump 498 (also in the present embodiment a Progressive Cavity Pump) receives matrix M from the vertical macerator 492.

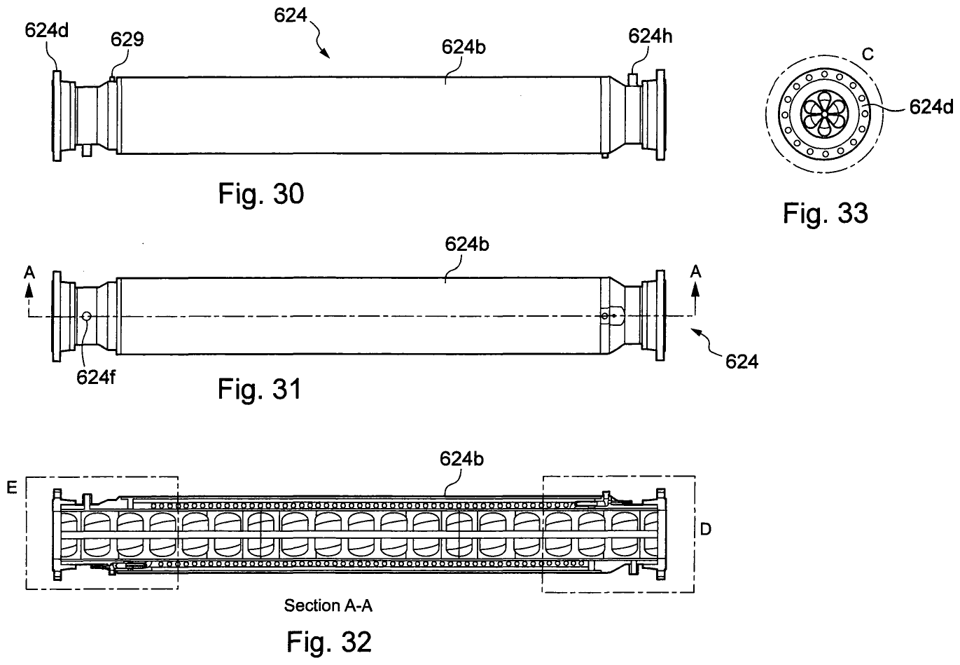

A third generator 624 is attached to the second pump 498. The third generator 624 is quite similar to both the first 424 and second generators 524 and analogous components use the same lettering scheme as used above e.g. the central tube section is 624a, the sleeve is 624b and so forth. FIGS. 30 to 37 show the third generator 624 in greater detail.

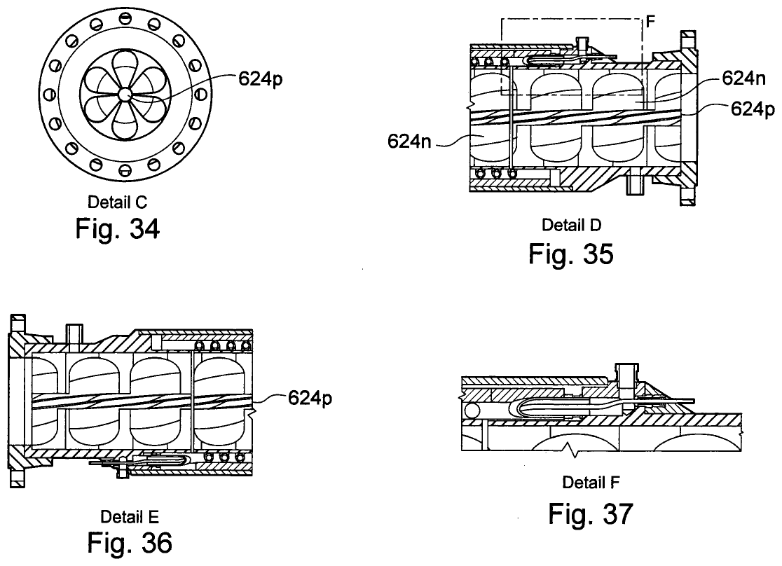

The main difference is that the ferromagnetic heating element 624g does have helical lobes provided within it, as well as being split into a plurality of discrete sub-chambers 624n. As can be seen from FIG. 34, the initial cross-section is of a hexafoil i.e. a six-lobed flower-like shape, and this shape is rotates about its central axis along the central axis of the ferromagnetic heating element 624g. A central, narrower bore 624p is provided along the length of the ferromagnetic heating element 624g, which connects each of the discrete sub-chambers 624n. The central, narrower bore 624p is formed with a greater helix pitch.

The second pump 498 drives the matrix M through the third generator, which incorporates fixed helical mixing profile inserts (i.e. the sub-chambers), against a die/pelletizer. Solids/pellets are collected on a conveyor for cooling and skipped or bagged. This final stage will be full ‘pipe flow’ (due to material being forced through a die) and also incorporates nitrogen inflow and vacuum draw. It is this final stage that may be used for the production of bio-char and syngas is some applications.

The liquid which condenses in the vacuum condensers 484 is drained into a liquid feed line 500 and is transported to the Treatment Skid portion of the apparatus.

The treatment skid comprises a primary filtration unit 448 which contains further absorbent A. Liquid enters the filtration unit 448 at the bottom and passes through layers of the further absorbent A. The liquid then passes to a second filter unit 449 before being collected in a condensate tank 444. With agricultural slurry the liquid will be water and, depending on the filtration efficiency, may be safe for environmental disposal, agricultural use or may even be potable.

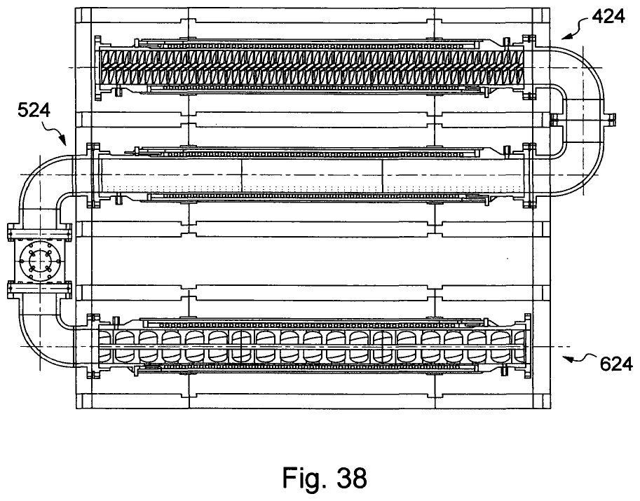

FIG. 38 is a side sectional elevation of the three generators 424, 524 and 624.

It will be appreciated by the skilled addressee that, depending on application, the exact type, sequence and number of generators may be varied. For example, a first and third generator may be used without an intervening second generator, or a second and third, and so forth. Moreover, the helical profiles of the various described elements within the generators may be altered, both in terms of such properties as pitch/chirality, but may also be altered to non-helical geometries.

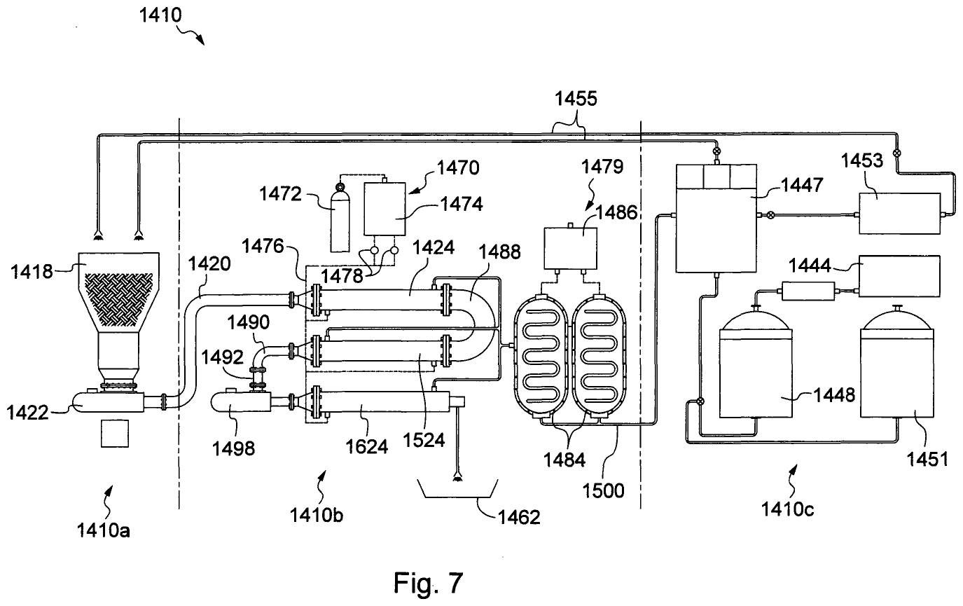

A fifth embodiment waste product method and apparatus 1410 are depicted in FIG. 7. These are very similar to the fourth embodiment method and apparatus 10 described above, and very similar or identical components are identified using the same numbering scheme as above, albeit prefixed with a “1”, except as described below.

The fifth embodiment 1410 is envisaged to handle oil sludges, hydrocarbon mixtures and so forth, but may be suitable to treat other fluid/liquid/semi-fluid materials.

The feed and generator skids are largely identical to the fourth embodiment, albeit that the chemical silos are omitted entirely.

The treatment skid 1410c is more appreciably different.

The treatment skid 1410c of the fifth embodiment comprises firstly a dissolved air flotation unit 1447. This separates the condensed liquid into water which flows out of the bottom of the unit 1447 and through pipework to a primary filtration unit 1448 which contains further absorbent A. Liquid enters the filtration unit 1448 at the bottom and passes through layers of the further absorbent A. The liquid then passes to a second filter unit 1449 before being collected in a condensate tank 1444.

An optional secondary filtration unit 1451 is provided in parallel to the primary unit, which also contains further absorbent A. Liquid enters the filtration unit 1448 at the bottom and passes through layers of the further absorbent A.

Hydrocarbon or otherwise oily sludge is pumped to a sludge tank 1453 or taken directly from the dissolved air flotation unit 1447. These are then re-routed back to the hopper/macerator for further processing by pipework 1455.

The skilled addressee will appreciate that the invention is not limited to the embodiment hereinbefore described, but may be modified in construction and/or detail.

For example, further inlets or outlets may be disposed along the length of the generator to enable specific fractions or chemicals to either be drawn off or fed into the process.

Although a whisky-based draff is discussed above as the absorbent, other suitable absorbents may be employed, such as draff from brewing process or other waste-products or by-products from agricultural processes or otherwise.

High temperature rated ultrasonic transducers or atomizers may be employed across all or only some of the generator sections 424, 524, 624. These will serve to vaporise entrained liquid rather than evaporate, further decreasing energy input into the system.

1. A method of treating waste products comprising the steps of adding an absorbent to the waste product to form a absorbed solid, semi-solid or fluid matrix, the matrix being then subjected to an increase in temperature.

2. The method of claim 1 wherein the matrix is fed through a channel, tube or other feature; the channel, tube or other feature having a length and a bottom surface along which the matrix traverses, there being a temperature increase applied along the feature's length.

3. The method of claim 2 wherein the feature includes one or more fluid aperture(s) along at least a portion of the bottom surface of the feature, and a gas is injected through said one or more aperture(s).

4. The method of any preceding claim wherein the gas is nitrogen.

5. The method of any preceding claim wherein ultrasound is applied to the matrix.

6. The method of any preceding claim wherein liquid obtained from the method is further treated by passing it through further absorbent.

7. The method of any preceding claim wherein the absorbent is draff.

8. The method of any preceding claim wherein liquid obtained from the method is further treated by use of a vapour vacuum process.

9. The method of any preceding claim wherein there are a plurality of features.

10. The method of any preceding claim wherein the matrix is macerated prior to entry into the one or more of the features.

11. Apparatus for treating waste products, the apparatus comprising a material inlet, a heated generator tube, one or more outlets being connected with the heated generator tube, and a material outlet.

12. The apparatus of claim 11 wherein the heated generator tube has a length and a bottom inner surface, there being a temperature increase applied along the heated generators tube's length.

13. The apparatus of any of claim 11 or 12 wherein there are one or more fluid aperture(s) along at least a portion of the bottom inner surface of the heated generator tube.

14. The apparatus of any of claims 11 to 13 further including a nitrogen supply connected to said one or more fluid apertures.

15. The apparatus of any of claims 11 to 14 further comprising one or more ultrasonic transducer(s) or atomizer(s).

16. The apparatus of any of claims 11 to 15 further comprising a filter having further absorbent.

17. The apparatus of any of claims 11 to 16 wherein the absorbent is draff.

18. The apparatus of any of claims 11 to 17 further comprising a vacuum pump to lower the boiling point of fluid contained in the matrix.

19. The apparatus of any of claims 11 to 18 further including one or more further heated generator tube(s).

20. The apparatus of any of claims 11 to 19 further including one or more macerators.

21. The apparatus of any of claims 11 to 20 further including one or more pumps.

22. The apparatus of any of claims 11 to 21 further including one or more pelletisers.
